(19) United States
(12) Patent Application Publication
(10) Pub. No.: US 2006/0242908 A1
(43) Pub. Date: Nov. 2, 2006

(54) Electromagnetic door actuator system and method

(76) Inventor: David Russell McKinney, West Jordan, UT (US)

Correspondence Address: DAVID R. MCKINNEY, P.C., 8 EAST BROADWAY, SUITE 500, SALT LAKE CITY, UT, 84111, US

(21) Appl. No.: 11/494,837

(22) Filed: Jul. 28, 2006

Related U.S. Application Data
(60) Provisional application No. 60/773,429, filed on Feb. 15, 2006.

(51) Int. Cl. E05F 15/00

(52) U.S. Cl. 49/280

(57) ABSTRACT

A door actuator system includes a linear motor, electromagnetically coupled between a moveable door and an adjacent non-moving structure, and a controller, interconnected to the linear motor, configured to power the linear motor to cause motion of the door, and to detect motion of the door from induced current produced in the linear motor.

### PRIORITY CLAIM

The present application claims priority from U.S. provisional patent application Ser. No. 60/773,429, filed on Feb. 15, 2006, and entitled ELECTROMAGNETIC DOOR ACTUATOR.

### BACKGROUND

1. Field of the Invention

The present invention relates generally to door actuators. More particularly, the present invention relates to an electromagnetic door actuator requiring no mechanical connection between the door and any actuating structure.

2. Related Art

There are a wide variety of door actuator devices. These include passive devices that operate to automatically close doors that have been opened manually, and powered devices that operate to both open and close a door. Passive door actuators include spring-actuated devices, pneumatic devices and hydraulic devices, for example. Hydraulic and pneumatic devices are very familiar and widely used with hinged or swinging doors, and sometimes also use springs in combination with the hydraulic or pneumatic device. These systems generally include an actuator unit, frequently installed above or at the top of the door, with an armature interconnecting the door panel to the adjacent wall or door frame. The unit provides resistance to opening the door, this resistance causing the door to automatically shut after being opened. However, the device also provides resistance to closure, thus damping and controlling the speed of closure, particularly near the end of the closing motion. This configuration causes the door to automatically close after being opened, and to do so more gently than is possible with a simple spring device, thus reducing the risk of harm or injury from a slamming door.

Powered door actuators that operate to both open and close doors are also widely used in many commercial buildings, such as supermarkets, hospitals, hotels, etc. These types of door actuators are typically electrical devices that include a conventional rotary electric motor that is mechanically connected to the door panel and operates to open or close the door. A motion detector, security switch, or other activation device can be used to activate the electric motor to open the door, and a timer or other electronics can be provided to cause the motor to close the door after a person has passed through, or after a set time, etc. Power door actuators can be used on both swinging doors and sliding doors, and can also be combined with pneumatic or hydraulic damping or attenuation devices. With swinging doors, the electric motor can be connected to a door axle or armature via a reduction gear device that converts rotation of the motor axle into rotation of the door axle or armature. Alternatively, an electric pump system can provide power to a hydraulic mechanism that opens and closes the door. With a sliding door, an electric motor can be associated with a rack and pinion or other gear system to convert rotational motion of the motor axle (or associated gears) into linear sliding motion of the door.

Unfortunately, known door actuator devices have several negative aspects. Passive door actuators impose significant resistance to opening a door, which can make it difficult for a child or an elderly or disabled person to open the door. Additionally, these doors will not stay open without continuous force being applied or a doorstop or other device being used. This can be very inconvenient in many circumstances. Additionally, passive door actuator devices tend to be bulky and unsightly, and if they malfunction, can cause a door to rapidly slam, which can be dangerous.

Power door actuators also tend to be bulky and unsightly, usually involving a large motor device located atop the door. Additionally, These devices are also somewhat noisy, and of course their mechanical parts are subject to wear. Furthermore, electric door actuators are not naturally configured to provide electronic output indicating the status of the door—whether closed or open, and how much. This information could be useful for building fire, security and access systems.

### SUMMARY

It has been recognized that it would be advantageous to develop a door actuator that is not bulky and obtrusive.

It has also been recognized that it would be advantageous to have a door actuator that is quiet and does not make the door difficult to open.

It has also been recognized that it would be advantageous to have a door actuator that can be integrated with building fire, security and access systems.

In accordance with one embodiment thereof, the present invention provides a door actuator system, including electromagnetic door actuator system, including a dynamic element attached to a door, and an elongate static element disposed adjacent to the dynamic element in a substantially fixed orientation with respect to the dynamic element throughout a range of motion of the door. The static and dynamic elements are portions of a linear motor, and each can be either a passive or active portion of the motor. The static element is configured to selectively impose an electromagnetic force upon the dynamic element, so as to move the door within its range of motion.

In accordance with a more detailed aspect thereof, the dynamic element is a permanent magnet and the static element is an array of induction coils, including a plurality of discrete electric coils arranged in sequence. The array of coils are configured to selectively receive power and provide an electromagnetic force upon the dynamic element so as to move the door within its range of motion.

In accordance with another more detailed aspect thereof, the door actuator system can further include a controller, configured to selectively provide current to the coils in the array.

In accordance with another more detailed aspect of the door actuator system, the dynamic element can include a coil, provided with electric power, and configured to interact with the elongate array to provide the electromagnetic force.

In accordance with another aspect thereof, the invention can be described as a door actuator system, including a dynamic motor element disposed in an edge of a door, and an elongate static motor element disposed adjacent to the edge of the door in a substantially fixed orientation with respect to the magnetic mass throughout a range of motion of the door. The system has an active mode, wherein at least one of the static and dynamic elements selectively receive power to provide an electromagnetic force upon the dynamic element to move the door, and a passive mode, wherein a characteristic of the motion of the door is detectable via current induced in a portion of the static element by motion of the dynamic element.

In accordance with yet another aspect thereof, the invention can be described as a method for actuating a door. The method includes the steps of selectively providing power to electric coils in an elongate array of electric coils, the array being disposed in a substantially fixed orientation with respect to a dynamic element in an edge of the door throughout a range of motion of the door, so as to move the door within the range of motion.

In accordance with still another aspect thereof, the invention can be described as a method for providing a door actuator, the method including the steps of providing a dynamic motor element attached to a door, and providing a static motor element in a fixed position adjacent to the door and having a substantially fixed orientation with respect to the dynamic motor element throughout a range of motion of the door. A further step includes selectively providing electric power to at least one of the static and dynamic motor elements, thereby moving the door within the range of motion.

### BRIEF DESCRIPTION OF THE DRAWINGS

Additional features and advantages of the invention will be apparent from the detailed description which follows, taken in conjunction with the accompanying drawings, which together illustrate, by way of example, features of the invention, and wherein:

FIG. 1 is a perspective view of one embodiment of a swinging door having an electromagnetic actuator according to the present invention;

FIG. 2 is a diagram representing an induction coil and showing the relationship between current in the windings and the induced electromagnetic force, and between current induced in the windings of the coil by motion of a nearby ferromagnetic mass;

FIG. 3a is a schematic diagram of a linear motor having an active dynamic element, and a passive static element;

FIG. 3b is a schematic diagram of a linear motor having a passive dynamic element, and an active static element;

FIG. 4a is a schematic diagram of a linear motor wherein both the static and dynamic elements are active;

FIG. 4b is schematic diagram of a linear motor having a an active dynamic element, and a static element including both active and passive portions;

FIG. 5 is a plan view of the door of FIG. 1;

FIG. 6 is an elevation view of the free end of the door of FIG. 1, showing the floor in cross-section;

FIG. 7 is a cross-sectional view of the free end of the door of FIG. 1, viewing the edge of the door and showing the floor in cross-section;

FIG. 8 is a block/schematic diagram of one embodiment of a control system for a door actuator system in accordance with the present invention;

FIG. 9 is a block/schematic diagram of an alternative embodiment of a control system for a door actuator system in accordance with the present invention;

FIG. 10 is a perspective view of one embodiment of a handheld remote activation device configured to activate an embodiment of a door actuator in accordance with the present invention;

FIG. 11 is a perspective view of a French door system having an embodiment of an electromagnetic door actuator system according to the present invention;

FIG. 12 is an elevation view of a sliding or pocket door having an embodiment of an electromagnetic door actuator system in accordance with the present invention;

FIG. 13 is a cross-sectional view of the free end of a door and adjacent floor having an embodiment electromagnetic door actuator with the static element installed flush with the finished floor surface;

FIG. 14 is an end cross-sectional view showing the free edge of a door and a longitudinal cross-section of a static array installed in the floor structure, the door being configured to close against a threshold;

FIG. 15 is a plan view of a door having an embodiment of an electromagnetic door actuator wherein the static element comprises a parallel set of two linear arrays of induction coils;

FIG. 16 is a plan view of an embodiment of a revolving door having an electromagnetic door actuator system in accordance with the present invention; and

FIG. 17 is a plan view of an embodiment of a “bat wing” door system having an electromagnetic door actuator system in accordance with the present invention.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

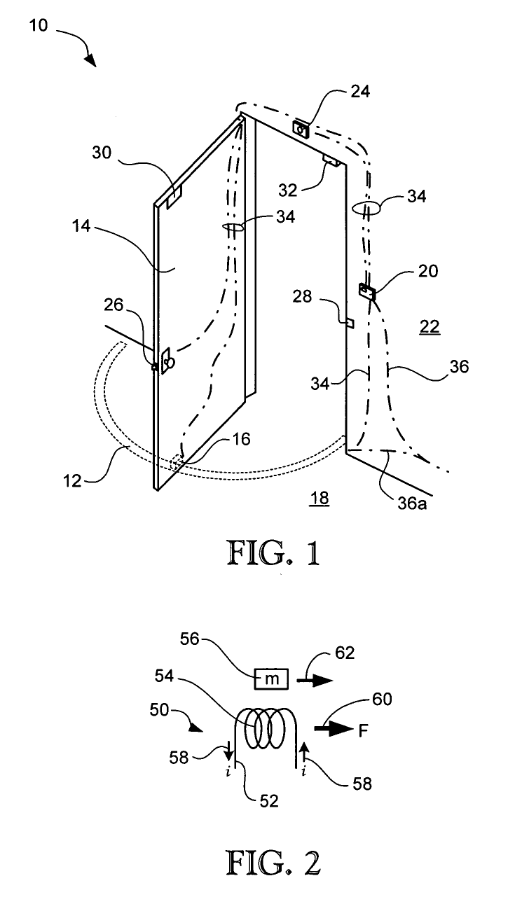

Shown in FIG. 1 is one embodiment of an electromagnetic door actuator system 10 in accordance with the present invention. The door actuator system generally comprises an elongate stator or static element 12 disposed adjacent to the path of motion of a door 14, and a dynamic element 16 attached to the door itself. In the embodiment shown in FIG. 1, the stator element is disposed upon or embedded within the floor 18 adjacent to the door, and the dynamic element is disposed in or on the bottom edge of the door 14. In this embodiment the door is a hinged or swinging door, and the stator element therefore has an arcuate shape, corresponding to the swing of the door. This configuration allows the relative positions of the static element 12 and dynamic element 16 to remain substantially constant throughout the range of motion of the door.

The door actuator system embodiment shown in FIG. 1 also includes a controller 20, which can be mounted on the wall 22 adjacent to the door, and a detector or activation device 24 that is also mounted near the door opening. While the controller and detector are shown in this embodiment as separate components, it will be apparent that the detector can also be incorporated into the body of the controller. The system can also include a power actuated door lock, which can comprise either or both a power actuated door knob/bolt assembly 26 installed in the door, and/or a power actuated bolt lock/strike plate mechanism 28 disposed in the door frame. Alternatively (or additionally) the door can be provided with an electromagnetic door lock comprising a magnetically active door plate 30 (typically installed near the top of the door) and a corresponding electromagnet 32 installed in the door frame. Such electromagnetic door locks are widely used and becoming increasingly popular. It will be apparent that these are only exemplary power actuated door lock systems, and many other types of door locking or latching systems can be configured to operate with the door actuator system described herein. The static element 12 and dynamic element 16, as well as the activation device 24 and door lock elements 26-32 are all interconnected to the controller 20, which controls their operation, and is described in more detail below.

The position of the dynamic element in the door is constant with respect to the position of the static element as the door swings. The windings of the induction coils are oriented such that current through any one of the coils will induce an electromagnetic force that is substantially tangent to the arcuate path of the coil array. This electromagnetic force interacts with the magnetic material in the door and creates a force that is substantially perpendicular to the plane of the door, causing the door to swing on its hinges. The direction of swinging depends upon the direction of the current in the coils. To move the door in either direction, the discrete coils are powered in sequence to essentially provide an electromagnetic wave that pushes the door. Because the door actuator has no mechanical connection to the door, use of the door in the normal manner is not hindered, and the effort required for an individual to open or close the door is substantially the same as if the door had no actuator of any kind.

Advantageously, the electromagnetic door actuator system employs a type of linear motor, but does so in a novel way. Linear motors, also called linear induction motors (LIM) are well known and used in a variety of applications. A linear motor is essentially a conventional rotary motor (either AC or DC) that has been cut and rolled out flat, with the stator stretched out along a line, and the equivalent of a rotor element configured to move along the length of the stator in a linear fashion, rather than rotating in a stationary position.

Linear motors can produce very large forces. They are widely used in robotics, material handling, and other industrial applications having both low and high power requirements, and are also used for propelling large transit and other tracked vehicles where very large forces are required. However, it will be apparent that the amount of force required to move a door is relatively small, both for swinging and sliding or rolling doors. Even fairly massive doors are easy for an individual to move when they are properly balanced and have only modest hinge friction. This is because where the door is plumb and properly balanced, the force required to open it is a lateral force, not a vertical force, and therefore does not have to resist gravity. Where gravity and other large resistive forces are not involved, a relatively small force can accelerate a relatively large mass to a speed appropriate to a moving door. Thus linear motors are perfectly suited to actuating doors.

Linear motors generally operate on the principle of electromagnetic induction. An illustration of electromagnetic induction is provided in FIG. 2. An induction coil 50 comprises an electrical conductor 52 (e.g. a metal wire) that is bent into a series of windings 54 that can be circular (i.e. helical) or non-circular. The windings can be about a magnetically active core (not shown), such as soft iron, though induction coils without a magnetic core are also used. Additionally, the coil can take the shape of a straight helix or a curved or partially curved helix (e.g. torroidal or semi-torroidal). When a magnetically active mass 56 (such as a permanent magnet or a piece of ferromagnetic material such as soft iron) is disposed near the coil, a current i passing through the coil in the direction of arrows 58 will create a magnetic field around the coil that will exert a force F upon the mass in the direction of arrow 60, this force tending to cause the mass to move in the direction of arrow 62.

Those skilled in the art will recognize that the direction of the force F depends upon the direction of the current i, and can be determined by the “right hand rule.” If the current is reversed from the direction shown, the force will be in the opposite direction from that shown. The magnitude of the force F depends upon a number of factors, including the magnitude of the current i, the number of windings 54 in the coil 50, and the proximity of the mass 56 to the coil. Additionally, it will be apparent that the density and shape of the magnetic field in the region of the mass 56 can vary depending upon the shape of the coil and the magnitude of the current i, among other factors.

It will also be apparent that the moving part of the system can be reversed from that shown in FIG. 2. The illustration of FIG. 2 presumes that the coil 50 is fixed and the mass 56 is free to move. However, that situation can be reversed, with the mass fixed and the coil free to move, in which case the principle of operation is just the same, except that the force F created by the coil will tend to cause the coil to move in the opposite direction—opposite to the direction of arrow 62.

Additionally, the principle of operation of the induction coil system can also be reversed. That is, the induction coil system as described above is operating in an “active” mode, with current i being supplied to the coil 50 in order to cause relative motion of the coil and mass 56. However, the system can also operate in a passive mode. Those familiar with induction coils recognize that when a magnetically active mass moves adjacent to an induction coil, the motion of the mass will induce a current in the coil. This principle is well understood and widely used, such as in highway traffic detector loops, wherein a coil of conductors is embedded in a traffic lane and connected to an intersection signal controller, for example. When a vehicle passes over the coil, its moving mass, which generally includes a large quantity of ferromagnetic material (e.g. steel and iron), induces a current in the induction coil, and that current is detected by the signal controller, which recognizes the arrival of a vehicle.

In the same way, the induction coil system depicted in FIG. 2 can operate in a passive mode. When the mass 56 moves adjacent to the coil 50, this motion will induce a current i in the coil. The magnitude and direction of this induced current will be proportional to the proximity, speed, and direction of motion of the mass, as well as the number of windings 54 and other physical characteristics of the coil. Consequently, a basic induction coil system can be used for both active production of mechanical motion, and in a passive mode to detect motion.

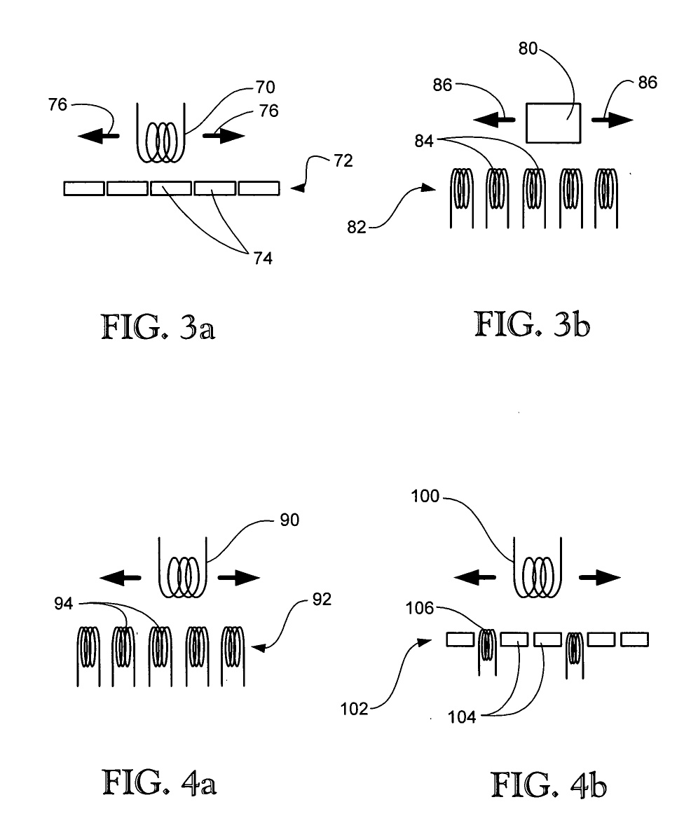

The application of the principles of induction in linear motors are illustrated in FIGS. 3 and 4. Linear motors are frequently referred to as having an “active” portion and a “passive” portion. The active portion is the part receiving electrical power, while the passive portion does not. Many linear motors are configured as shown in FIG. 3a, with a powered induction coil 70 moveably disposed adjacent to an elongate track 72 of individual magnetic elements 74, such as permanent magnets. The elongate track is sometimes referred to as a “magnet track.” Linear motors frequently employ high-power rare earth magnets, and such rare earth magnets can be used in the various embodiments of electromagnetic door actuators disclosed herein. One advantage of this configuration is that the magnet track can be made as long as desired, and is relatively inexpensive, allowing the system to be relatively economically adapted to a variety of applications. While the coil 70 is shown as a single coil, this is for representative purposes only. The coil can comprise an assembly of multiple coils to provide the desired inductive force. In the embodiment of FIG. 3a, the coil 70 is the active portion, configured to selectively move in the direction of arrows 76 depending upon the direction of current in the coil, and the magnet track 72 is the passive portion of the linear motor.

The designations “active” and “passive” should not be confused with the designations “static” and “dynamic” used above, because the active and passive portions of a linear motor can be reversed from the configuration shown in FIG. 3a. That is, the active portion of a linear motor can be either the static or dynamic element, and vice versa. For example, shown in FIG. 3b is a configuration wherein a magnetically active mass 80, being the passive portion of the linear motor, is the moving or dynamic element, and an elongate array 82 of coils 84 is the active portion of the motor, but is the static element of the system. The coils in the array of coils can be powered in the manner shown in FIG. 2 simultaneously or in series, or in some other fashion, so as to selectively move the mass in the direction of arrows 86 as desired. Additionally, the configuration of FIG. 3b can operate in a passive mode, with the motion of the magnetic mass 80 inducing electrical current in the coils 84, the magnitude and direction of this induced current indicating the speed and direction of the mass. Additionally, if the position and identity of the particular coils in which current is induced is known, the position of the mass can also be determined.

Other configurations are also possible. Active and passive motor portions can be provided and operated in different arrangements than those shown in FIGS. 3a and 3b. for example, shown in FIG. 4a is a linear motor system wherein both the static and dynamic motor elements can be active coil portions. In this system the dynamic element is a moveable coil 90, and the static element is an array 92 of coils 94. In this system, each of the static and dynamic elements can operate as active or passive elements. For example, a constant flow of power can be provided to the moveable coil 90 so that the coil's electromagnetic behavior is similar to that of a permanent magnet, while the coils 94 in the array 92 are selectively powered to move the moveable coil in the manner of the system of FIG. 3a. Alternatively, a constant flow of power can be provided to the coils in the array so that the array behaves like a series of permanent magnets, while power is selectively provided to the moving coil to cause motion in the manner of the system of FIG. 3b. As yet another alternative, power to the moving coil 90 and the static array of coils 94 can both be manipulated to provide the desired motion. Likewise, the coils in the array can be used in a passive mode to detect the position, speed, and direction of motion of the moving coil in the manner discussed above with respect to FIG. 3b

Additionally, a combination of coils and permanent magnets can also be used in either the active or passive portions of a linear motor. One such configuration is shown in FIG. 4b. In this configuration, a powered induction coil 100 is moveably disposed adjacent to an elongate track 102 comprising individual magnetic elements 104 and coils 106. The coils in the track can be at any desired spacing relative to the magnetic elements, and can operate in a passive mode to detect the position and motion of the moveable coil. The coils in the track can also be used in an active mode to provide motive force to the moving coil in the manner discussed above with respect to FIGS. 3b and 4a. The dynamic element in any of the embodiments shown in FIGS. 3 and 4 (e.g. coil 100 in FIG. 4b) can also employ a combination of coils and permanent magnets.

Referring back to FIG. 1, the door actuator system 10 employs a linear motor system with the dynamic element disposed in or on the door 14, and the static element 12 of the motor disposed in or on the floor 18 adjacent to the door. However, the dynamic element of the actuator system can be either an active or passive element of the linear motor system or a hybrid (such as shown in FIG. 4b), and the static element of the actuator system can likewise be an active or passive or hybrid motor portion. This configuration gives the door actuator system a wide range of operational and control possibilities, discussed in more detail below.

As noted above, the static element 12 is disposed adjacent to the door 14 so as to have a substantially fixed position with respect to the motion of the door. For a swinging door as shown in FIG. 1, this position can be in the floor 18, but other positions are also possible, such as a ceiling above the door or some other position. It will also be apparent that the position of the static element can be different for other doors types, such as sliding doors.

It should be noted that the terms “linear” and “elongate” as used herein with respect to the static array are not intended to limit the static array to a straight line. The static array can be straight (e.g. for sliding doors) or it can be circularly curved (e.g. for a swinging door) or it can be curved in other ways (e.g. for a bifold door). Thus, the term “linear” includes curvilinear and other elongate shapes.

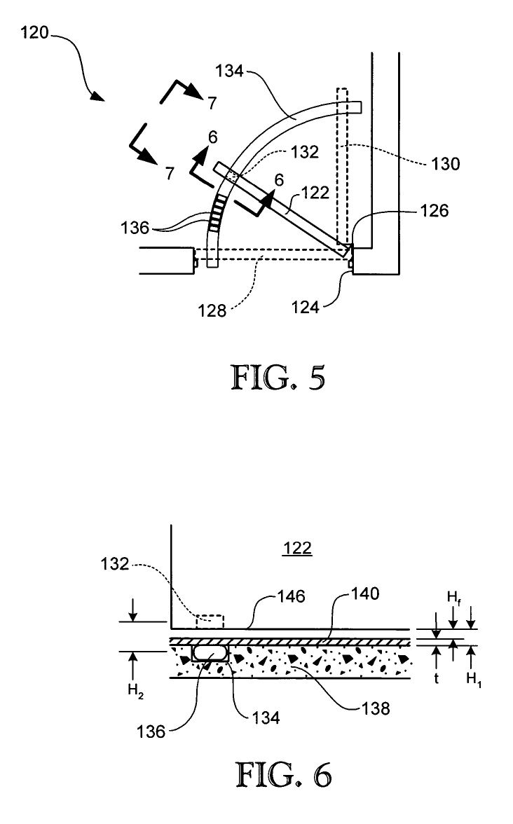

Shown in FIG. 5 is a plan view of a door system 120 having an electromagnetic actuator similar to that of FIG. 1. The door 122 is attached to a door frame 124 via hinges 126, and swings between a closed position 128 (shown in dashed lines) and an open position 130 (shown in dashed lines). A dynamic motor element 132 is disposed within the door panel, and a static motor element 134 is disposed in a position corresponding to the door swing. As noted above, the dynamic element can be the passive portion of the actuator and the static element can be the active portion or vice versa, or both the static and dynamic elements can be active or be switchable between active and passive modes.

The door 122 and door actuator system shown in FIG. 5 are configured for a door having an approximately 90° swing. Accordingly, the static element 134 comprises an arcuate array that defines an approximately 90° arc. However, the arc of the static element can be any desired angle. For example, the arc of the static element 12 (and the associated door 14) in FIG. 1 is about 180°. Likewise, the door opener system 550 shown in FIG. 14 (described below) is configured for a 180° door swing. Other angles can also be used for swinging doors.

As noted above, the static element comprises an elongate array of motor elements, whether forming the active or passive part of the motor, or a combination of both. Referring to FIG. 5, the static element 134 comprises an elongate array of individual motor elements 136. These elements can either be inductions coils or magnetic elements, or both, and the induction coils can operate in either the active or passive mode, as described above.

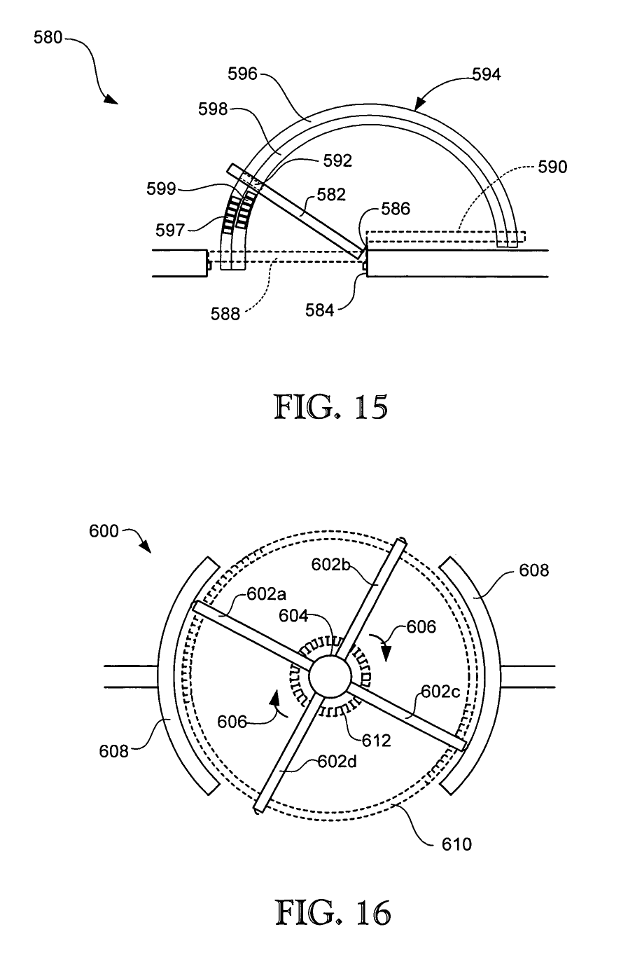

The static array can be configured in various other ways, too. Shown in FIG. 15 is a plan view of an alternative embodiment of a door opener system 580 having a dual array static element 594. Like the embodiment of FIG. 5, the door 582 is attached to a door frame 584 via hinges 586, and swings between a closed position 588 (shown in dashed lines) and an open position 590 (shown in dashed lines) that is approximately 180° from the closed position. A dynamic motor element 592 is disposed within the door panel, and the static motor element 594 is disposed in a position corresponding to the door swing path. Like the embodiment shown in FIG. 5, the dynamic element can be the passive portion of the actuator and the static element can be the active portion or vice versa, or both the static and dynamic elements can be active or be switchable between active and passive modes. Moreover, the dynamic element can comprise multiple elements (e.g. multiple coils and/or permanent magnets, such as one corresponding to each array), or be a single unitary element (either a coil or permanent magnet positioned adjacent to both arrays).

Like the embodiments described above, the static element 594 comprises an elongate array of motor elements, whether forming the active or passive part of the motor, or a combination of both. These elements can either be inductions coils or magnetic elements, or both, and the induction coils can operate in either the active or passive mode, as described above. However, unlike the embodiment of FIG. 5, the static element shown in the embodiment of FIG. 15 comprises a first elongate array 596 of motor elements 597, and a second elongate array 598 of motor elements 599. The placement of two elongate arrays side-by-side can provide several benefits. First, more motor elements can allow the application of more force to the door. Additionally, the motor elements of the respective arrays can be staggered in position, so that the elements of one array generally correspond to gaps between motor elements of the other array. This can help smooth out the operation of the door opener system, preventing or reducing the occurrence of electromagnetic “bumps” throughout the motion of the door. Further, the provision of multiple arrays can increase the resolution of position sensing and control of the door.

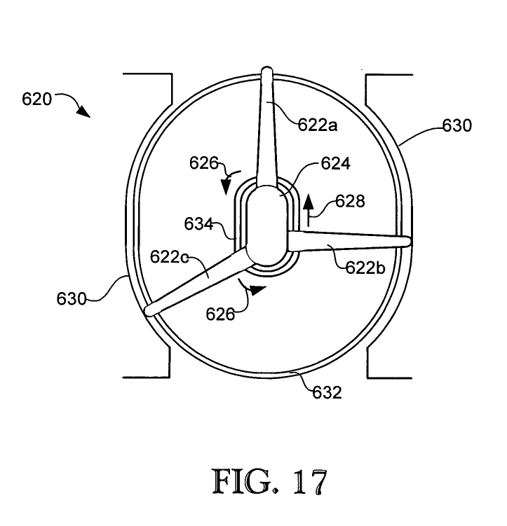

It will also be apparent that where multiple static arrays are provided, these need not be side-by-side. Specifically, a configuration like that shown in FIGS. 16 and 17 with respect to revolving and bat wing doors, respectively, wherein one static array (610 in FIG. 16) is located near the perimeter of the door swing, and another array (612 in FIG. 16) is located closer to the swinging axis of the door, can also be applied to a conventional swinging door. Indeed, multiple static arrays can be positioned at various locations relative to the door swing. Spacing them apart can also help reduce problems with electromagnetic interference between one array and the other.

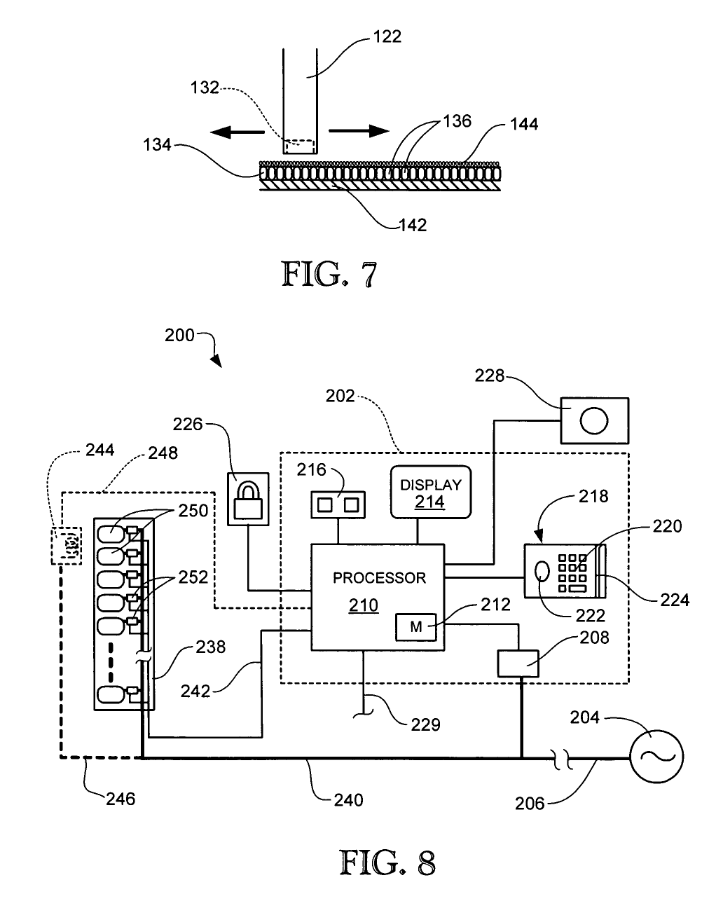

The views of FIGS. 6 and 7 show the elevational relationship between the static array and the dynamic element in the door in two different installations. Advantageously, because there is no mechanical connection between the static element and the door itself, the static array can be installed in a subfloor structure, and be entirely hidden from view beneath a finished floor. For example, as shown in FIG. 6, the static array 134 can be embedded in a concrete subfloor 138, with a finished floor material 140 disposed atop the array. The finished floor can be any type of floor material, such as wood, tile, terrazo, carpet, vinyl, etc. Likewise, the subfloor can be any of a wide variety of materials, such as concrete, wood, etc. For example, FIG. 7 depicts a wood subfloor 142 supporting the static array 134, with carpeting 144 (e.g. carpet and pad) disposed over the top of the array.

Different types of subfloors will introduce different installation considerations. For example, installation in a building having a wood subfloor may require the cutting (e.g. using a router or the like) of an arcuate trench in the subfloor to accommodate the static array. This approach can be desirable because it allows the static element of the linear motor to be installed after the door frame is in place, thus helping ensure that the array is placed in the proper position. Where the subfloor comprises multiple layers (e.g. of plywood or OSB), the static array can be installed in a suitably shaped slot in just the topmost layer of the subfloor, depending upon the thickness of the array. Where the static array is installed in a concrete subfloor, the array can potentially be thicker than could be installed in a wood subfloor. The installation of the static array in a concrete subfloor can be done in various ways. For example, the array can be embedded in the surface of the wet concrete when the floor is first installed. Alternatively, a blank having the shape and size of the array can be embedded in the wet concrete, then removed later, after the concrete has at least partially cured, leaving a trench of the appropriate size and shape for installation of the array. Conduits and other structure needed to allow interconnection of the array with electrical power and control electronics can also be provided in the concrete floor structure. It will be apparent that the installation methods mentioned here are only exemplary, and that other installation methods can also be followed.

The thickness of the array can depend on whether the array is a passive or active portion of the linear motor, and on the amount of force that is to be applied to the door. For example, where the static array comprises a series of permanent magnets, the array can be designed to be no thicker than a single layer of ¾″ plywood, and thus fit easily into the design of a residential or light commercial building (though this configuration will still be compatible with concrete and other heavier floor structures). As for the weight of the door, for lightweight residential interior doors (e.g. hollow core doors) the amount of force required to open or close the door may be so small that an array comprising a series of induction coils can be configured to be as thin or almost as thin as an array of permanent magnets. On the other hand, where the doors are heavier, such as fire or security doors, and more force is required, a suitable array of induction coils may be thicker. A thicker array can be easily accommodated in a concrete subfloor, though some special design considerations may be required if the array is thicker than the subfloor. Where a wood subfloor is used, special design considerations may be required to accommodate a thick array. Those skilled in the art of structural design will be able to determine the structural requirements to embed the static array in the subfloor.

Potential interference problems should also be considered. For example, in a concrete subfloor, it may be desirable to adjust the position of reinforcing steel to avoid interference with the magnetic flux of the door actuator system. It is likewise desirable that the finished floor material not interfere with the electromagnetic operation of the door actuator. For example, iron or steel material in close proximity to the door actuator, such as floor plates or hardware, could interfere with the magnetic flux generated by the induction coil(s). A suitable distance between such materials and the door actuator system is desirable. However, it is also possible that the system can be designed to compensate for some amount of magnetic interference.

As noted above, the dimensions of the static and dynamic elements of the linear motor depend in part on the geometry of the door system. For example, viewing FIG. 6, there is normally an unfinished clearance or gap H₁ between the top of the subfloor 138 and the bottom edge 146 of the door. The distance H₁ can vary from as little as a few millimeters up to several inches, 1 to 3 inches being a common range of clearance. While there are industry standards generally in use, this clearance can differ depending upon the type of construction (e.g. whether residential or commercial), the type of the subfloor (e.g. whether wood or concrete), and the material (e.g. carpet, vinyl, wood) of the finished floor 140. Given the thickness t of the finished floor material (which varies), this unfinished gap allows for a final clearance H_{f} between the bottom edge of the door and the finished floor surface.

The geometry and design of the static array 136 and the dynamic element 132 will depend upon the size of the gap H₁, the type and weight of the door, and the type of subfloor, as well as the configuration of the linear motor (i.e. whether the static array is active or not). In view of the various design parameters, the static and dynamic elements will thus each have some final size such that there is a final clearance H₂ between the center of the static element 136 and the center of the dynamic element 132, with the top of the array flush with the top surface of the subfloor. Where the static array is an array of induction coils, the coils must be configured to produce a magnetic field that encompasses the dynamic element (e.g. a permanent magnet) whose center is a distance H₂ away, and provide the desired force thereupon. It will be apparent that, where the distance H₁ is greater and all other factors are equal, more power may be required by the active portion(s) of the door actuator to provide the needed force. Having both the static and dynamic elements be active motor portions (i.e. both including induction coils) can also allow the provision of more power to the system. Other factors can also be manipulated to provide the required power across the gap. For example, the shape and size of the induction coils and/or permanent magnets can be manipulated to provide the required magnetic flux in the region of the dynamic element. Those skilled in the design of induction coils and linear motors will be able to design suitable motor portions to operate for a variety of door/actuator gap conditions and provide the required magnetic field.

It will also be apparent that the gap between the door and the static motor portion can vary throughout the range of motion of the door and from door to door in a particular installation. For example, typical construction tolerances for door clearance and flatness of floors are generally quite loose compared to the geometric tolerances typically applied in the design of linear motors. Consequently, the door actuator must be designed to operate within a range of door gap conditions, such as where the gap in a given door varies slightly across the range of its motion, and where multiple doors that are intended to have the same gap are all provided with door actuators having the same set of specifications, but the actual gap varies from door to door.

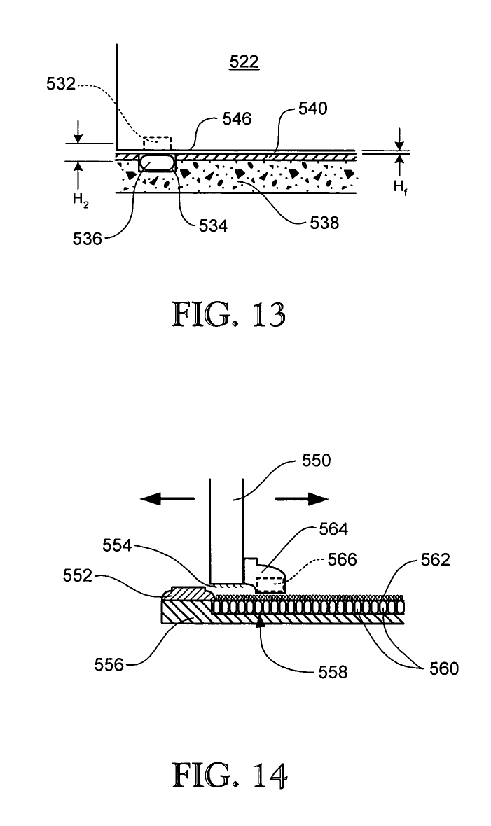

While an electromagnetic door actuator as described herein can be installed beneath a finished floor surface, it can also be installed such that its top surface is flush with the finished floor surface. This sort of installation can be used where minimizing the gap between the linear motor elements is desirable for increasing force upon the door. Shown in FIG. 13 is a cross-sectional view of such an installation. In this configuration, the static array 534 is embedded in the subfloor 538 (shown as concrete in this installation), and a finished floor material 540 is installed around (but not atop) the static array. To minimize the gap between the motor elements even further, the height of the bottom edge 546 of the door 522 above the surface of the finished floor (H_{f}) can also be reduced. Consequently, the gap between the top of the static element 536 and the dynamic element 532 of the actuator will be equal to the gap H_{f} between the top of the finished floor and the bottom edge of the door. Likewise, the gap H₂ between the center of the static array and the center of the dynamic element will also be reduced. By minimizing the motor gap and ensuring that the gap is substantially constant (e.g. through careful construction of the door and floor), the door actuator can be made more efficient. This can allow the actuator system to provide a higher and more consistent motive force to the door throughout its range of motion, and/or to use less electrical power to provide a given output.

An alternative approach to minimizing the gap between the motor elements can also be applied, and this approach also applies to doors that nest into a threshold. Shown in FIG. 14 is a door 550 that is configured to swing into a close fit with the top of a threshold 552. The bottom edge of the door includes a door sweep structure 554, such as a series of fins, that help provide a weathertight fit between the door and the threshold. As is typical, the threshold rises above the level of the finished floor 562, so that the door can swing freely. However, this increased height of the bottom edge of the door also increases the gap between the bottom edge of the door and the coils 560 in the static array 558 of the door opener system.

In order to reduce this gap, in the embodiment of FIG. 14 the dynamic element 566 is located in a fixture 564 that extends behind and below the door. This fixture places the dynamic element in a position that reduces the motor gap, yet does not conflict with the position of the threshold. Placing the dynamic element in a fixture that attaches to the door, rather than inside the door edge itself, is applicable to other door configurations as well, and is not limited to use with doors mated to a threshold. For example, this approach can be convenient in retrofit situations, where a door opener system in accordance with this disclosure is installed on an existing door. This can allow the dynamic element to be attached to the door, without requiring more extensive modification that may be needed to embed the dynamic element within the door. This approach can also be useful for metal doors in order to reduce or prevent possible disruption of electromagnetic fields that a metal door structure might present.

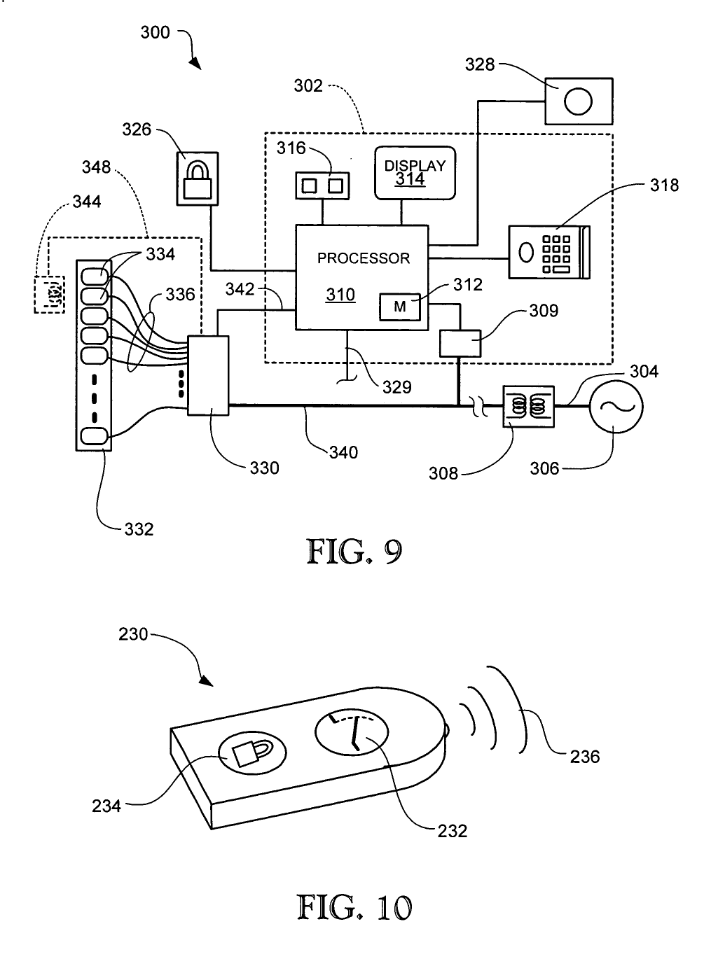

Shown in FIGS. 8 and 9 are two embodiments of controller systems that can be used with the electromagnetic door actuator disclosed herein. As noted above with respect to FIG. 1, the door actuator system can include a controller 20, a detector or activation device 24, and may also include any of a variety of power actuated door lock systems. All of these systems are connected via electric and communication lines 34 to the controller 20. In addition, the controller is electrically connected to a power supply (e.g. AC or DC power) through line 36, and may also be electronically connected to communicate with other systems (e.g. fire and security control systems). The lines 34 and 36 are intended to represent electrical interconnection, whether for power or communication and control, and do not necessarily represent a single conductor. Thus electrical power can be passed through the controller to each element of the system through lines 34, as well as communication and control signals.

A schematic diagram of one configuration of a control system 200 for the door actuator of FIG. 1 is shown in FIG. 8. In this figure, the controller module 202 (corresponding to controller 20 in FIG. 1) is connected to an electrical power supply 204 via power line 206 (36 in FIG. 1). Where the linear actuator system is to operate on alternating current (AC) but the controller is a DC device, a transformer 208 can be provided to produce the appropriate voltage and power supply for the controller. Alternatively, where the linear actuator also operates on direct current, a transformer can be provided in the original power supply line, as shown in FIG. 9. The controller generally includes a microprocessor 210 having memory 212, and can also include a visual display 214 (e.g. an LCD display screen) and control input devices 216 (e.g. push buttons, switches, etc.) to allow a user to program and control the system. Such systems are widely used with digital thermostats and the like.

The controller 202 can also include a security input panel 218, which can include a variety of input devices that can be used for security access purposes and the like. For example, the security input panel can include a number keypad 220 for allowing a user to enter a security or other code, a biometric detector 222 (e.g. a fingerprint reader), and a card reader 224 for allowing a user to swipe a magnetic strip on an identification or access badge or card or the like to activate the system. While certain specific input devices are shown in FIG. 8, these are only exemplary, and the system is not limited to the specific examples shown.

The control system can include other elements that are interconnected to (or integrated into) the controller 202. For example, one or more power actuated door lock devices 226 (e.g. power actuated door knob/bolt/lock/strike plate mechanism or electromagnetic door lock 26-32 in FIG. 1) and a detector/activation device 228 (24 in FIG. 1) can be connected to the controller. An external communication line 229 can also be provided to provide communication between the controller and other devices, such as a fire or security system, other door controllers, etc.

The detector/activation device 228 can be any of a variety of devices. For example, it can be a motion detector or heat detector, which signals the door actuator system to open (or close) the door upon detecting motion or heat (or failing to detect motion or heat over a time interval) in close proximity to the door. Other types of detector/activation devices can also be used. For example, the detector activation device can be a radio frequency receiver or infrared receiver configured to receive a signal from a remote control device carried by a user. One embodiment of such a device is shown in FIG. 10. This device is a small handheld remote control unit 230 configured like keyless remote entry devices widely used for automobiles. It can include a door control button 232 and a lock control button 234. The device is configured to broadcast a signal (e.g. radio frequency or infrared), represented by waves 236, which is detected by the detector/activation device 228. Pressing the lock control button can cause the remote device to send a signal to lock or unlock the door, and pressing the door control button can cause the remote device to send a signal to open or close the door. This handheld remote control system can be desirable for convenience and also as part of a security system. For example, remote control devices with specific broadcast codes can be distributed to employees of a company, with certain doors responding only to certain codes, thereby controlling access to portions of the company's facility. A cellular telephone or PDA can also be configured to function as a remote actuation device. Since such devices are commonly configured to transmit RF or IR signals, the door actuator system can be configured to detect and act upon an actuation signal transmitted by one of these devices.

A small wireless remote like that shown in FIG. 10 can also be designed for use on a desktop or other position separated from a door. This can enable a secretary, an executive, or other person to control the motion of a door without having to get up and walk to the door. Thus, for example, an executive can close his door for a private meeting or to shut out hallway noise without having to get up from his desk and interrupt his work. Similarly, a secretary, doorman, or security guard can remotely open (or lock) a nearby door to admit or exclude persons without having to leave their work station. The worker simply presses a button on the remote device to achieve the desired function. Since the remote control device is wireless, it is extremely flexible in its use and there is no need to provide wiring between it and the door controller.

The controller components shown disposed within the dashed outline of the controller 202 in FIG. 8 can be housed within a single controller device, though they need not all be included therein, and other elements of the system not shown therein can also be included within the controller. As discussed above, the power supply for the static array 238 (12 in FIG. 1) can flow through the controller 202, or it can bypass the controller and flow directly to the static array through power line 240 (36a in FIG. 1). Control signals to the static array are provided from the processor 210 via control line 242. Where the dynamic element 244 (16 in FIG. 1) is an active portion of the linear motor, power to that element can be provided through power line 246, and control signals via control line 248.

The static array 238 shown in FIG. 8 comprises a series of static elements 250. In one embodiment, the static elements are passive (e.g. permanent magnets), and the dynamic element 244 is an active induction coil, like the embodiment shown in FIG. 3a. The coil receives electrical power through power line 246 and control signals from the controller through line 248. The static elements require no electrical or other connection to the controller. The controller controls the timing, magnitude and direction of current to the coil to cause the door actuator to move the door.

In another embodiment, some or all of the static elements 250 can be individual induction coils. Where all of the static elements are coils the configuration can be like that shown in either of FIGS. 3b and 4a. In either of these configurations the dynamic element can be a coil 244 that operates as described above, or it can be a permanent magnet. Where only some of the static elements are coils, the configuration can be like that shown in FIG. 4b, with the dynamic element being a coil. Associated with each coil in the static array is a coil control chip 252 that receives control signals from the microprocessor 210 via the control line 242, and electrical power through power line 240. The control chip includes semiconductor switches and current controlling devices that control the magnitude and direction of current provided to the associated coil. The coil control chips can also include circuitry for detecting current passively induced in the associated coil, and to send signals to the microprocessor indicating the magnitude and direction of that induced current. In this way, the microprocessor can independently address each coil and control the magnitude and direction of current in each coil, and can also detect current induced in each coil.

The coil control chips 252 can be configured like well-known PIC processors, which each have a unique digital address and are configured to receive, store, and execute a digital command string. In this case, the coil control chips can be configured to control the magnitude and direction of current to each coil in the active mode, and to detect the magnitude and direction of current in the passive mode. The microprocessor 210 can be programmed with the address of each coil control chip, and thus can specifically send and receive control signals to/from each coil. Having a separate control chip for each coil allows the entire array of control chips to be connected using a one, two- or three-wire conductor.

A single 3-conductor wire can be used to interconnect all of the coil control chips. The 3-conductor wire can include a data line, a ground line, and a power line. The power line provides electrical power to each coil control chip, while the data line carries unique control signals to each chip. The control signals are differentiated by the unique digital address of each coil control chip, so that each control chip responds only to control signals that are intended for it.

Alternatively, if desired, the control chips can be connected by a two-conductor wire, rather than a three-conductor wire, with one conductor being a ground wire, and the other being both the power and data line. In this embodiment, control signals for the coil control chips can be superimposed upon the DC current traveling through the power/data wire. Each chip can include a voltage regulator and a resistor divider network and internal analog comparator to allow the control signals to be distinguished from the background electrical current, so that the one data/power wire can provide both power and independent control data to each node. While this configuration allows a smaller conductor cable, the additional hardware associated with each coil control chip will tend to increase the size and bulk of the coil control chips.

Advantageously, the controller microprocessor 210 can be configured to send and receive data at a very high rate (e.g. 57600 BPS), allowing individual commands to be sent to individual coil control chips (i.e. one command to each unique address) very rapidly. The controller can also be configured to send out other types of commands, such as family commands—i.e. commands received and executed by a specific set or group of coil control chips. For example, address ranges, rather than one specific chip address, can be specified when sending commands. Alternatively, the interface can send global commands—commands received and executed by all chips and their associated coils in the array.

An alternative embodiment of a controller system 300 for a door actuator system as described herein is shown in FIG. 9. Like the controller system of FIG. 8, this configuration includes a controller module 302 connected to an electrical power supply 304 via power line 306 (36 in FIG. 1). This configuration is shown as being a purely DC system, with a transformer 308 connected to the power supply to convert AC to DC. However, where the linear actuator system is to operate on AC but the controller is a DC device, a transformer can be associated with a power conversion module 309 associated with the controller, while the transformer 308 is eliminated.

The controller includes the same elements as the system of FIG. 8, including a microprocessor 310 having memory 312, a visual display 314 and control input devices 316. The controller can also include a security input panel 318 like that described above with respect to FIG. 8, and the control system as a whole can also include a power actuated door lock 326, a detector/activation device 328, and an external communication line 329.

Unlike the system of FIG. 8, the controller system of FIG. 9 includes an interface 330 that is interconnected between the processor 310 and the static array 332 via communication line 342. Control signals are provided to the interface from the processor 310 via control line 342, while electrical power for the static array flows to the interface through power line 340. While the interface is shown as a separate component that is outside the controller body 302, the interface can also be included within the controller body. Alternatively, the interface can be included as part of the static array assembly.

The static array 332 comprises a series of static elements 334, which can be passive elements (e.g. permanent magnets), or active elements (e.g. induction coils) or a combination of both, as described above. Unlike the system of FIG. 8, however, where the static elements are coils, the configuration of FIG. 9 does not include a coil control chip for each coil. Instead, the interface 330 receives control signals from the processor 310 and separates these signals into specific instructions for each coil in the static array, and then directly routes power to specific coils in the array through lines 336. Where the dynamic element 344 is an active portion of the linear motor, power to that element is also provided from the interface 330 through line 348, the interface adjusting power to the dynamic element based upon control signals from the processor 310.

The interface 330 includes switches and current controlling devices that control the magnitude and direction of current provided to each coil and/or the dynamic element 344. The interface also includes circuitry for detecting current that is induced in the coils, so that when the coil array is operating in the passive mode, the interface detects the magnitude and direction of any induced current, determines the identity of the coils producing the current, and routes this information to the processor. In this way, the microprocessor can independently address each coil and control the magnitude and direction of current in each coil for powering the door actuator in the active mode, and in the passive mode can also detect current induced in each coil to determine the position and speed of the door at any given moment.

It will be apparent that the configuration of FIG. 9 requires a separate power line 336 to each coil in the array. However, this configuration does not require a separate processor for each coil, though still providing the same functionality as the system of FIG. 8. Those skilled in the art will also recognize that the system can be provided with other features to make it safe, efficient, reliable and robust. For example, heat dissipation devices such as heat sinks may be desirable to prevent overheating of coils, etc. Other features to protect the system from short circuits, etc. can also be included. It will also be apparent that control systems different from those described herein can also be devised to control a door actuator as described herein. The control systems shown in FIGS. 8 and 9 are only two of many possible embodiments.

This door actuator system with its controller allows great flexibility. In the active mode, current can be specifically provided to individual coils so as to produce an electromagnetic wave of a desired shape and configuration to push the door along at a specifically desired speed. Because of this design, current is not wasted powering coils that are not adjacent to the door. Additionally, since there are multiple coils in the coil array and the controller can identify each one, the static array can be used in a passive mode to sense the position, speed, and direction of the door when it is moving. That is, when no power is provided to a given coil, the motion of the dynamic element adjacent to the coil will induce a current as it passes over. The magnitude and direction of that induced current depends upon the direction and speed of motion of the door and the proximity of the dynamic element to that coil. Consequently, the identity of the coils that experience the induced current and the magnitude, direction, and change in that current over time will indicate the position, direction, and speed of the door.

The door actuator thus has a passive mode and an active mode. In the active mode, the linear motor provides a force upon the door to either open or close the door (or provide any other motion) at any desired speed. In the passive mode, the coils can sense the position, direction, and speed of motion of the door. When motion ceases, the controller can store a value in memory (212 in FIG. 8, 312 in FIG. 9) indicating the last known position of the door. In this way the controller can always know the position and status of the door.

This information about the motion and position of the door can be very useful for security, fire control, and other systems. For example, in a building having a security system, the status of each door having an actuator as described herein—both when the door is moving and when it is static—can be transmitted to a central control or monitoring center, allowing security personnel and/or others to constantly know the status of each powered door and also to control them remotely. For example, this type of control and feedback can be very useful for firefighters and other emergency personnel.

Advantageously, the system can switch between active and passive modes rapidly, to both propel the door, and detect its position and motion while it is moving to determine the amount and timing of additional force needed to control the door as desired. For example, initial movement of the door from a stopped position to some operating velocity generally only requires the application of force for a brief period of time. If the door is well balanced and presents only modest friction in the hinges, after initial acceleration, the door will tend to swing under its own momentum (depending upon the mass of the door) without the need for additional force. During this free swinging time period, the door actuator device can switch to passive mode and monitor the position and speed of the door. As the door nears the portion of its motion where it needs to be stopped, the actuator can then switch to active mode and apply a stopping force (a force opposite in direction to the force that commenced movement) to bring the door to a stop. The controller can be programmed to calculate the magnitude and duration of force required to bring the door to a stop based upon the speed of the door and the force initially applied to move the door.

By switching between active and passive mode the control system can also apply diagnostic routines or error recovery routines. For example, if the system attempts to power the door, then switches to passive mode to detect the position of the door but receives no signal, this can indicate that the door was not in the position the controller had previously stored in memory. In such a situation the system can be configured to “find” the door by powering the array of coils in various ways to cause the door to move regardless of its position. For example, the system may first power all coils in a manner so as to close the door, then quickly switch to passive mode to detect the door's position and motion. If that is not successful (e.g. the door was already closed), the system can power all coils to cause the door to open, then quickly switch to passive mode to detect that motion. Other recovery routines can also be provided.

In any of these operations, the system can be switched between active and passive modes at almost any desired frequency to detect the progress of the operation. It will be apparent that the frequency of switching between active and passive modes may be limited by residual current and other transient effects in the coils and circuitry. However, those skilled in electrical engineering will be able to design the system to reduce these transient effects and allow switching at a suitable frequency.

With the assistance of the passive mode, the controller can “learn” the exact characteristics of a given door, and adjust its output accordingly. For example, the controller can be programmed to produce some maximum angular velocity for the door. By checking the speed of the door repeatedly during its transition from a stopped to a moving condition, or vice versa, the controller can obtain feedback regarding the amount of current and time duration required to start or stop the door with respect to the maximum velocity. If the door is particularly heavy, for example, the system can detect a slow acceleration condition and adjust the current provided to the coils to allow faster acceleration, if desired. The system can also detect the effects of friction by noting a change in velocity during a free swinging interval, and provide a compensatory force to maintain a relatively constant moving speed for the door if desired, or simply determine how much less force will be required to stop the door compared to that which was applied to start it. The system can then store in memory the operational adjustments that need to be made according to the data determined through these feedback operations, and then operate accordingly in the future, and periodically update this operational data based on later feedback.

The passive mode can also be used to sense obstructions and other unusual conditions. If, while the door is moving, it is stopped before it reaches its normal (e.g. programmed) stop position, the system can be programmed to switch to active mode and provide a modest additional force to attempt to overcome the obstruction. However, if this additional force is insufficient, this can indicate a more significant blockage, and the system can be programmed to stop movement of the door and provide an error message or other indication to a user to attend to the problem.

Another desirable aspect of the door actuator system is its ability to selectively apply force at different levels at different parts of the motion range. For example, a door may require more force at the very beginning or end of its motion to overcome the resistance or friction of a latch. Thus, when closing the door, the system can be configured to provide additional force at the very end of the motion to allow it to overcome the resistance of the latch.

The use of multiple coils allows a variety of other advantageous features. The door actuator can be used as a doorstop, with opposite current provided to coils on opposing sides of the door to provide opposing forces on the door to keep it in place. Additionally, the system can prevent slamming of a door by detecting (in passive mode) the speed and motion of a door at the outset of a slamming motion, and rapidly providing an opposing force to slow its motion before it closes. The system can similarly prevent a door from flying open and potentially damaging walls or other items behind the door.

Other uses are also possible. For example, the door actuator system can be configured to normally rest in passive mode. When a user opens the door, the system can be configured to detect this, then automatically close the door after a given time interval or after a motion detector no longer detects motion. In this way the system can operate in the same manner as a passive door closure device, but without resisting opening of the door, and without a bulky and unsightly mechanical device attached to the door.

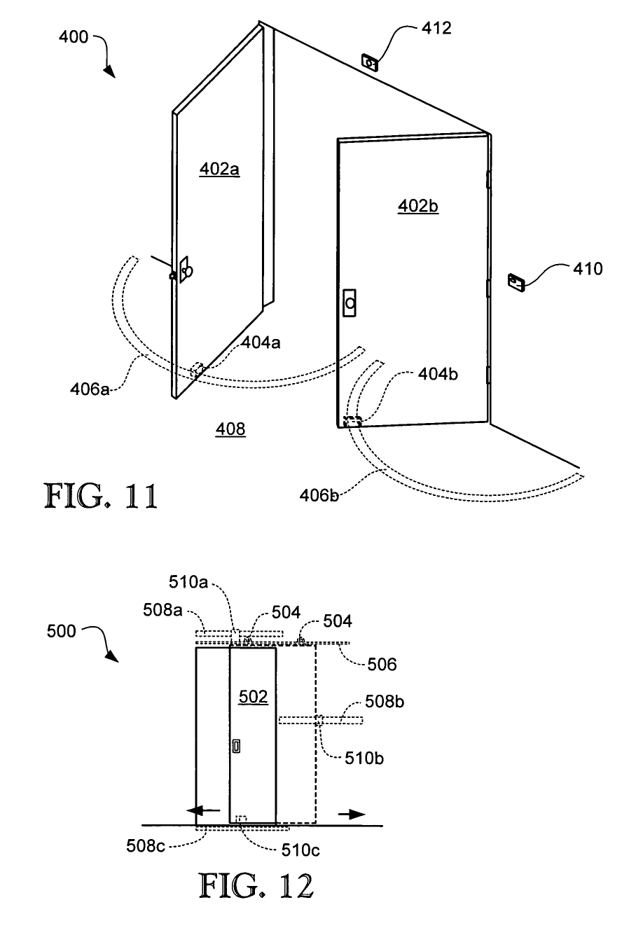

Another feature of this system is that it can provide coordinated control of multiple doors. Shown in FIG. 11 is a French door assembly 400 including two doors 402a and 402b that close together and open in opposing directions. Each door includes a dynamic element 404, and a static motor element 406 is disposed in the floor 408 below each door. A controller 410 can be mounted on the wall adjacent to the door pair, and a detector 412 can also be associated with the system. The controller can be configured in many ways. For example, it can cause one door to mimic the motion of the other, so that when a user moves one door of the pair the controller will passively detect this motion and activate the other static array to cause the other door of the pair to move at the same speed in the same direction. In this way one user can open or close two doors at the same time while touching only one door of the pair. Alternatively, the controller can be set to cause just one door of the pair to move in the various ways described above for a single door, or to automatically move both doors simultaneously, or any other combination. Other features described above, such as power locks, etc., can also be associated with coordinated multiple door systems.

While the discussion above has focused on swinging doors, the door actuator system can also be used with sliding or pocket doors. An example of a sliding door system 500 having an electromagnetic door actuator as described herein is shown in FIG. 12. In the embodiment depicted in the figure the sliding door 502 is a pocket door that is attached via rollers 504 to an overhead track 506. As shown in the figure, the overhead track is installed within the wall above the door, though this is only one of many configurations for sliding doors.

The components of the linear motor of the electromagnetic door actuator for the sliding door system 500 can be positioned in several different places. For example, the door actuator can comprise a static array 508a that is located above the door, and a dynamic element 510a that is attached to the top of the door. Alternatively, the door actuator can comprise a static array 508b that is disposed within a wall behind the door, and a dynamic element 510b that is attached to the back of the door. As another alternative, the door actuator can comprise a static array 508c that is disposed on or within the floor below the door, and a dynamic element 510c that is attached to or within the bottom of the door. In this embodiment the static array is arranged in a straight line, rather than an arc, but operates in the same manner as described above with respect to swinging doors.

Other applications for an electromagnetic door actuator as described herein are shown in FIGS. 16 and 17. Provided in FIG. 16 is a plan view of a revolving door that is provided with an embodiment of an electromagnetic door actuator. As with typical revolving doors, the revolving door system 600 includes four door panels 602a-602d (though it can have more or less than four panels) that are rigidly attached to a central rotating hub 604. When a user pushes on one of the door panels, this causes the central hub to rotate, causing all of the door panels to rotate in the direction of arrows 606 within the curved door enclosure 608, allowing users to pass through the door in succession.

Advantageously, a revolving door shown in FIG. 16 can be provided with an electromagnetic door actuator as described herein. In the embodiment shown in FIG. 16, a static array 610 is embedded in the floor of the door enclosure, and corresponding dynamic elements (not shown) are provided in each door panel. The diameter of the static array 610 can vary. In FIG. 16 the static array is shown having a diameter almost as large as the diameter of the revolving door. This configuration helps provide high torque for moving the door, and also makes the static array longer, which can help increase its sensitivity when in the passive mode. The system can also include an inner static array 612, though this is optional. Indeed, multiple static arrays can be provided adjacent to any of the door actuator embodiments disclosed herein. In the configuration of FIG. 16, the inner array 612 can work in conjunction with the outer array 610 to provide additional force. It will also be apparent that one or more static arrays can be provided in a ceiling above the door panels, as opposed to or in addition to being installed in the floor.

Other types of doors can also be provided with an electromagnetic door actuator as described herein. Shown in FIG. 17 is a plan view of a “bat wing” door system 620 that is provided with an electromagnetic door actuator system in accordance with the present invention. Bat wing door systems are similar to revolving doors, but are designed to allow passage of larger groups of people and things in a single rotational gap. Such doors are now frequently used at hospitals, airports, and other locations to allow ingress and egress of groups of people and luggage, carts, stretchers etc. The bat wing door system includes several door panels 622a-622c that rotate around a central pillar 624. Unlike a revolving door, the central pillar is not circular and does not rotate about a fixed axis. Instead, the central pillar is elongated, and the door panels are configured to undergo a rotational motion (as indicated by arrows 626) when at the curved ends of the central pillar, and to experience a substantially linear motion (as indicated by arrow 628) when disposed along the substantially flat sides of the central pillar. The outer edges of the door panels abut the inside of the elongated door enclosure 630 during a portion of their motion.

The bat wing door system shown in FIG. 17 includes a static array 632 that is disposed near the outer ends of the door panels, and corresponding dynamic motor elements (not shown) are disposed in the door panels and positioned adjacent to the static array. As with the revolving door, placing the door actuator elements near the outer edges of the door panels helps increase the force that these will provide. The system can also include an inner static array 634 that is located near the central pillar 624. Since the motion of the door panels is not purely circular motion, common control of inner and outer arrays can be coordinated to prevent or resist any tendency toward racking, twisting, or binding of the door panels.

The system can also be configured to compensate for changing velocity of the door panels. The linear velocity of the outer or free end of a door panel in the bat wing door system is not constant. It will be apparent that when the inner connected ends of the door panels move with substantially constant linear velocity around the curved and straight portions of the central pillar, the free ends of the doors will experience substantially that same velocity when moving in the straight portion of the motion, but will have much greater velocity in the curved portions, because of the greater length of the curved path. Accordingly, the control system of the electromagnetic door actuator can be programmed to provide a greater velocity to the door panels during the curved part of their motion than during the straight portion. Likewise, the flexibility of the system with active and passive modes can inner and outer

The aspects of control flexibility discussed above can also be incorporated into a revolving or bat wing door. For example, the system can be set to normally rest motionless in passive mode, and then switch to active mode and begin moving when a user approaches (e.g. using a motion detector) or when the system senses (in passive mode) that a user has applied some threshold amount of force to the door to cause it to move. Additionally, the electromagnetic door actuation system can provide various safety and security features. For example, the power actuated door can assist persons (e.g. children, the elderly or handicapped, etc.) in moving what might otherwise be a heavy door, and once moving, ensure that the motion is with a constant and reasonable speed. Likewise, the controller can be configured to limit the maximum speed of the door, which can help prevent accidents. It can also prevent (or allow) reverse motion. As a security measure, the system can provide a locking mode wherein electromagnetic force is used to prevent motion. Likewise, the system can be used for security and fire detection purposes as discussed above.

The invention thus provides a door actuator that is quiet, efficient, and can be completely hidden from view, and which does not hinder use of the door in the standard manual way, for swinging doors, sliding doors, revolving doors, batwing doors, and others. Moreover, there are no bulky and unsightly mechanical devices attached to the door, and no moving parts to wear out from friction or contact with the door. The door actuator is compatible with a variety of types of construction, including wood, concrete, or any other material commonly used for building subfloors, or even an outdoor surface. Additionally, the system can be installed in new construction, or can be retrofitted to existing door installations. The dynamic element can be installed in or on an existing door, and the static element can be installed in the floor (or other suitable location) adjacent to the door by routing, cutting, or otherwise forming a slot or trench. The controller can then be connected to the dynamic and/or static elements and to a power supply by the appropriate routing of wires, thus providing a complete installation.

By way of example, and without limitation, the invention can be described as an electromagnetic door actuator system, including a dynamic element attached to a door, and an elongate static element disposed adjacent to the dynamic element in a substantially fixed orientation with respect to the dynamic element throughout a range of motion of the door. The static and dynamic elements are portions of a linear motor, and each can be either a passive or active portion of the motor. The static element is configured to selectively impose an electromagnetic force upon the dynamic element, so as to move the door within its range of motion.

In a more detailed embodiment thereof, the dynamic element is a permanent magnet and the static element is an array of induction coils, including a plurality of discrete electric coils arranged in sequence. The array of coils are configured to selectively receive power and provide an electromagnetic force upon the dynamic element so as to move the door within its range of motion.

In a more detailed aspect thereof, the door actuator system can further include a controller, configured to selectively provide current to the coils in the array.

In another more detailed aspect of the door actuator system, the dynamic element can include a coil, provided with electric power, and configured to interact with the elongate array to provide the electromagnetic force.

As another example, the invention can be described as a door actuator system, including a dynamic motor element disposed in an edge of a door, and an elongate static motor element disposed adjacent to the edge of the door in a substantially fixed orientation with respect to the magnetic mass throughout a range of motion of the door. The system has an active mode, wherein at least one of the static and dynamic elements selectively receive power to provide an electromagnetic force upon the dynamic element to move the door, and a passive mode, wherein a characteristic of the motion of the door is detectable via current induced in a portion of the static element by motion of the dynamic element.

As yet another example, the invention can be described as a method for actuating a door. The method includes the steps of selectively providing power to electric coils in an elongate array of electric coils, the array being disposed in a substantially fixed orientation with respect to a dynamic element in an edge of the door throughout a range of motion of the door, so as to move the door within the range of motion.

As yet another example, the invention can be described as a method for providing a door actuator, the method including the steps of providing a dynamic motor element attached to a door, and providing a static motor element in a fixed position adjacent to the door and having a substantially fixed orientation with respect to the dynamic motor element throughout a range of motion of the door. A further step includes selectively providing electric power to at least one of the static and dynamic motor elements, thereby moving the door within the range of motion.

It is to be understood that the above-referenced arrangements are only illustrative of the application of the principles of the present invention in one or more particular applications. Numerous modifications and alternative arrangements in form, usage and details of implementation can be devised without the exercise of inventive faculty, and without departing from the principles, concepts, and scope of the invention as disclosed herein. Accordingly, it is not intended that the invention be limited, except as set forth in the following claims.

What is claimed is:

1. An electromagnetic door actuator system, comprising:
a) a door, having a range of motion;
b) a dynamic element, attached to the door, comprising a moving portion of a linear motor;
c) an elongate static element, disposed adjacent to the dynamic element in a substantially fixed orientation throughout the range of motion, the static element comprising a static portion of a linear motor; and
d) a controller, electrically coupled to at least one of the static and dynamic elements, and configured to selectively provide electrical power to actuate the linear motor and cause motion of the door.

2. A door actuator system in accordance with claim 1, wherein at least one of the static and dynamic elements have an active mode, in which electrical power provided to said element causes motion of the door, and a passive mode, in which motion of the door produces an induced electrical current in at least one of the motor elements, the controller being a microprocessor device configured to detect a magnitude and direction of the induced electrical current and to determine characteristics of motion of the door therefrom.

3. A door actuator system in accordance with claim 2, wherein the controller is configured to switch between active and passive modes during a single motion episode of the door, to detect motion of the door when in passive mode, and to adjust power to the motor elements when in active mode to either change or maintain the motion of the door.

4. A door actuator system in accordance with claim 2, wherein:
e) the static element comprises an array of discrete induction coils arranged in a linear sequence, each induction coil having a unique digital address and configured to control a flow of current to and from the respective coil; and
f) the controller is configured to determine a relative position, direction of motion, and speed of motion of the door based upon a magnitude and direction of induced current from each coil when in passive mode, and to control a speed and direction of motion of the door by sending current to selected coils when in active mode.

5. A door actuator system in accordance with claim 1, wherein the dynamic element comprises a permanent magnet, and the static element comprises an array of discrete induction coils arranged in a linear sequence.

6. A door actuator system in accordance with claim 1, wherein the dynamic element includes a coil, configured to electromagnetically interact with the elongate array.

7. A door actuator system in accordance with claim 1, wherein the door is a swinging door having a pivoting axis, and the static array comprises a circularly arcuate array centered about the pivoting axis.

8. A door actuator system in accordance with claim 1, wherein the static array is disposed in a floor structure below the door.

9. A door actuator system in accordance with claim 8, wherein the static array is disposed below a finished floor surface of the floor structure.

10. A door actuator system in accordance with claim 1, wherein:
e) the door comprises first and second adjacent doors, each door having a complementary range of motion and including a dynamic element attached thereto, and an elongate static element disposed adjacent to the dynamic element in a substantially fixed orientation throughout the range of motion of the respective door, the static and dynamic elements comprising respective portions of first and second linear motors; and
f) wherein the controller is electrically coupled to the first and second linear motors, and is configured to selectively provide electrical power to actuate the first and second linear motors and cause motion of the first second doors.

11. A door actuator system in accordance with claim 10, wherein
g) at least one of the static and dynamic elements associated with each door have an active mode, in which electrical power provided to said element causes motion of the respective door, and a passive mode, in which motion of the respective door produces an induced electrical current in at least one of the motor elements; and
h) the controller is configured to detect a magnitude and direction of induced electrical current and to determine characteristics of motion of the first door therefrom in passive mode, and to adjust power to the motor elements of the second door in active mode to cause motion of the second door that is complementary to the motion of the first door.

12. A door actuator system in accordance with claim 1, further comprising a remote actuation device, configured to provide an actuation signal to the controller, the remote actuation device being selected from the group consisting of a motion detector installed near the door, and a handheld cordless remote actuation device.

13. A door actuator system, comprising:
a) a linear motor, electromagnetically coupled between a moveable door and an adjacent non-moving structure; and
b) a controller, interconnected to the linear motor, configured to power the linear motor to cause motion of the door, and to detect motion of the door from induced current produced in the linear motor.

14. A door actuator system in accordance with claim 13, wherein the linear motor comprises:
c) a dynamic motor element, disposed at an edge of the door; and
d) a static motor element, disposed adjacent to the edge of the door and only electromagnetically coupled to the dynamic motor element, the static motor element having
i) an active mode, wherein electrical power provided to the static motor element produces an electromagnetic force upon the dynamic motor element to move the door; and
ii) a passive mode, wherein a characteristic of motion of the door is detectable via current induced in a portion of the static element by motion of the dynamic element therenearby.

15. A door actuator system in accordance with claim 14, wherein the dynamic motor element is disposed in a bottom edge of a swinging door having a pivoting axis, and the static motor element comprises a circularly arcuate array of induction coils disposed in a floor structure beneath the door and centered about the pivoting axis.

16. A door actuator system in accordance with claim 13, wherein the static motor element comprises an array of individually addressable induction coils arranged in a linear sequence, and wherein the controller is electrically connected to each induction coil and configured to determine a relative position, direction of motion, and speed of motion of the door based upon a magnitude and direction of induced electrical current from each coil when in passive mode, and to control a speed and direction of motion of the door by sending electrical current of a selected magnitude and direction to selected coils when in active mode.

17. A door actuator system in accordance with claim 13, further comprising a remote actuation device, configured to provide an actuation signal to the controller, the remote actuation device being selected from the group consisting of a motion detector installed near the door, and a handheld cordless remote actuation device.

18. A method for actuating a door, comprising the step of:
a) selectively providing power to uniquely identifiable electrical coils in an elongate array of electrical coils disposed in a substantially fixed position with respect to a dynamic element at an edge of a door throughout a range of motion of the door, so as to move the door within the range of motion.

19. A method in accordance with claim 18, further comprising the steps of
b) detecting electrical current induced in the electrical coils by non-powered motion of the dynamic element therenearby; and
c) determining characteristics of motion of the door based upon the magnitude and direction of the induced current and the position of the coil which produced the induced current.

20. A method in accordance with claim 18, further comprising the step of providing an actuation signal to a controller associated with the elongate array and the dynamic element via a remote actuation device, so as to control actuation of the door.
